(19) United States
(12) Patent Application Publication
(10) Pub. No.: US 2013/0057452 A1
(43) Pub. Date: Mar. 7, 2013

(54) HIGH-FREQUENCY MODULE AND HIGH-FREQUENCY DEVICE USING THE SAME

(71) Applicant: Hideki WATANABE, Miyagi-ken (JP)

(72) Inventor: Hideki WATANABE, Miyagi-ken (JP)

(21) Appl. No.: 13/604,057

(22) Filed: Sep. 5, 2012

(30) Foreign Application Priority Data
Sep. 5, 2011 (JP) 2011-193082

(51) Int. Cl. H01Q 1/50

(52) U.S. Cl. 343/905

(57) ABSTRACT

On a circuit board of the high-frequency module, an RF circuit and an antenna element are arranged, and transmission lines between both the RF circuit and the antenna element are provided. The transmission line of the RF circuit side among the transmission lines is led-out from the top of the circuit board to a rear surface side of the circuit board through a via hole, and the transmission line of the antenna element side is led-out from the top of the circuit board to the rear surface side through another via hole. Electrical continuity between tip portions of the transmission lines is blocked off on the rear surface of the circuit board; however, when the high-frequency module is mounted on the motherboard, a bridging connection land is soldered to each of the tip portions, so that the transmission lines are connected with each other.

### CLAIM OF PRIORITY

This application claims benefit of Japanese Patent Application No. 2011-193082 filed on Sep. 5, 2011, which is hereby incorporated by reference in its entirety.

### BACKGROUND OF THE DISCLOSURE

1. Field of the Disclosure

The present disclosure relates to a high-frequency module that has an RF circuit and an antenna element and is suitable for wireless communication, and the like, and a high-frequency device that mounts this kind of high-frequency module on a motherboard.

2. Description of the Related Art

In recent years, by surface mounting a high-frequency module in which an RF circuit and an antenna element are arranged on a circuit board on a motherboard of each of various portable terminals, a high-frequency device (a wireless communication device or a broadcasting receiver) in which wireless communication and broadcast reception are made possible has become popular. Typically, this kind of high-frequency module may perform characteristic measurement for performance evaluation or adjustment of the RF circuit at the assembly stage, and may be surface mounted by mounting the circuit board of the high-frequency module on a predetermined region of the motherboard after desired performance of the RF circuit is confirmed.

Regarding this kind of device of the related art, FIG. 9 is a plane view of a major part of a high-frequency module according to the related art, and FIG. 10 is a plane view of a major part showing a pattern shape obtained by removing a switching connector from FIG. 9.

In the high-frequency module 30 shown in FIG. 9, a pattern antenna 32 is provided at one end of a circuit board 31 as an antenna element, and an RF circuit is provided at the other end of the circuit board 31, which is not shown. A measurement electrode 33a is provided at a tip portion of a first transmission line 33 that extends toward a pattern antenna 32 from the RF circuit, and a measurement electrode 34a is provided at a tip portion of a second transmission line 34 that extends toward the RF circuit from the pattern antenna 32. As shown in FIG. 10, even though the transmission line between the measurement electrodes 33a and 34a is interrupted, a central conductor 36a of the switching connector 36 is soldered to the measurement electrodes 33a and 34a as shown in FIG. 9, so that the first and second transmission lines 33 and 34 are conducted through the central conductor 36a to thereby become a series of transmission lines. In addition, on the circuit board 31, two measurement ground lands 35 led-out from a ground conductor which is not shown are provided in the vicinity of the measurement electrodes 33a and 34a, so that the measurement ground lands 35 may be soldered to an external conductor 36b of the switching connector 36.

In the high-frequency module 30, in order to perform characteristic measurement for performance evaluation or adjustment of the RF circuit, a measurement plug, which is not shown is inserted into the switching connector 36 from the above. In this manner, when the measurement plug is inserted, the switching connector 36 blocks off electrical continuity between the measurement electrodes 33a and 34a, so that signal transmission and reception between the RF circuit and the pattern antenna 32 cannot be performed. Therefore, by a measurement device, which is not shown, that is connected to the measurement plug, a transmission operating characteristic or a reception operating characteristic of the RF circuit may not be measured. In addition, when the inserted measurement plug is removed, the switching connector 36 continues the electrical continuity between the measurement electrodes 33a and 34a, so that the signal transmission and reception between the RF circuit and the pattern antenna 32 can be performed. Thus, the high-frequency module 30 capable of confirming the desired performance of the RF circuit is surface mounted on a motherboard, which is not shown, to allow the high-frequency module 30 to be connected with a control circuit, and the like, whereby wireless communication or broadcast reception may be performed.

In addition, in Japanese Unexamined Patent Application Publication No. 2002-353841, a high-frequency module in which a switching connector is interposed on a transmission line between an RF circuit and an antenna element has been disclosed.

Japanese Unexamined Patent Application Publication No. 9-257852 discloses a high-frequency module in which a general coaxial connector is mounted without using the switching connector. In the high-frequency module of the related art, a relatively inexpensive coaxial connector is connected to the transmission line of the RF circuit side in comparison with the switching connector, so that a tip of the transmission line faces the transmission line of the antenna element side while having a predetermined gap on the circuit board therebetween. The characteristic measurement for the performance evaluation or adjustment of the RF circuit may be performed by inserting the measurement plug into the coaxial connector, and then the signal transmission and reception between the antenna element and the RF circuit having the desired performance may be performed by directly bridging the transmission lines of both ends of the gap through a chip component such as a chip condenser or the like, or by directly bridging the transmission lines by soldering.

However, since the switching connector 36 shown in FIG. 9 is a connector of a complex structure having an on/off switching function, the switching connector 36 is a relatively expensive component in comparison with a general connector used for connection. Thus, as disclosed in Japanese Unexamined Patent Application Publication No. 2002-353841, in the case of the high-frequency module in which the switching connector is interposed on the transmission line between the RF circuit and the antenna element, a problem arises in that it is difficult to reduce manufacturing costs due to an increase in the cost of parts.

In the case of the high-frequency module disclosed in Japanese Unexamined Patent Application Publication No. 9-257852, in order to bridge the transmission line of the RF circuit side and the transmission line of the antenna element side, a separate operation such as additionally mounting the chip component or soldering using a soldering iron, or the like, is necessary even though an inexpensive coaxial connector is used. In other words, the man-hours for assembling are increased even though the increase in the cost of parts is suppressed, so that it is not easy to reduce the manufacturing costs even in the high-frequency module having the above described configuration.

### SUMMARY

According to a first aspect, there is provided a high-frequency module which is used in a manner such that transmission lines are provided between an RF circuit and an antenna element while the RF circuit and the antenna element are arranged on a circuit board, and the circuit board is surface mounted on a motherboard, wherein a second transmission line of the antenna element among the transmission lines is led-out from the top of the circuit board to a rear surface side of the circuit board through a second via hole while a first transmission line of the RF circuit side among the transmission lines is led-out from the top of the circuit board to the rear surface side through a first via hole, so that a tip portion of the first transmission line and a tip portion of the second transmission line are arranged on a rear surface of the circuit board to thereby block off electrical continuity between both the tip portions, and both the tip portions are soldered to a solder connection land provided on the motherboard when the circuit board is surface mounted on the motherboard, so that the first transmission line and the second transmission line are connected to each other.

In the high-frequency module configured as above, electrical continuity between the first transmission line of the RF circuit side and the second transmission line of the antenna element is blocked off until the high-frequency module is mounted on the motherboard, so that, even though an expensive switching connector is not used, characteristic measurement of the RF circuit can be performed by connecting an inexpensive coaxial connector to a part of the first transmission line on the circuit board, by bringing a probe into contact with the part of the first transmission line, or the like.

### BRIEF DESCRIPTION OF THE DRAWINGS

FIG. 1 is a perspective view showing the whole of a high-frequency module according to a first embodiment of the present invention;

FIG. 2 is a main part plan view of FIG. 1;

FIG. 3 is a main part plan view showing a pattern shape obtained by removing a switching connector from FIG. 2;

FIG. 4 is a plan view showing the whole of a pattern shape of the rear surface side of a circuit board shown in FIG. 1;

FIG. 5 is a main part cross-sectional view for describing a state in which characteristic measurement of an RF circuit is performed using the high-frequency module shown in FIG. 1;

FIG. 6 is a main part cross-sectional view for describing a high-frequency device in which the high-frequency module shown in FIG. 1 is surface mounted on a motherboard;

FIG. 7 is a main part plan view showing a pattern shape formed in a mounting region of a high-frequency module on an upper surface of the motherboard shown in FIG. 6;

FIG. 8 is a main part plan view showing a pattern shape of a high-frequency module according to a second embodiment of the invention;

FIG. 9 is a main part plan view for describing a high-frequency module according to the related art; and

FIG. 10 is a main part plan view showing a pattern shape obtained by removing a switching connector from FIG. 9.

### DESCRIPTION OF THE EXEMPLARY EMBODIMENTS

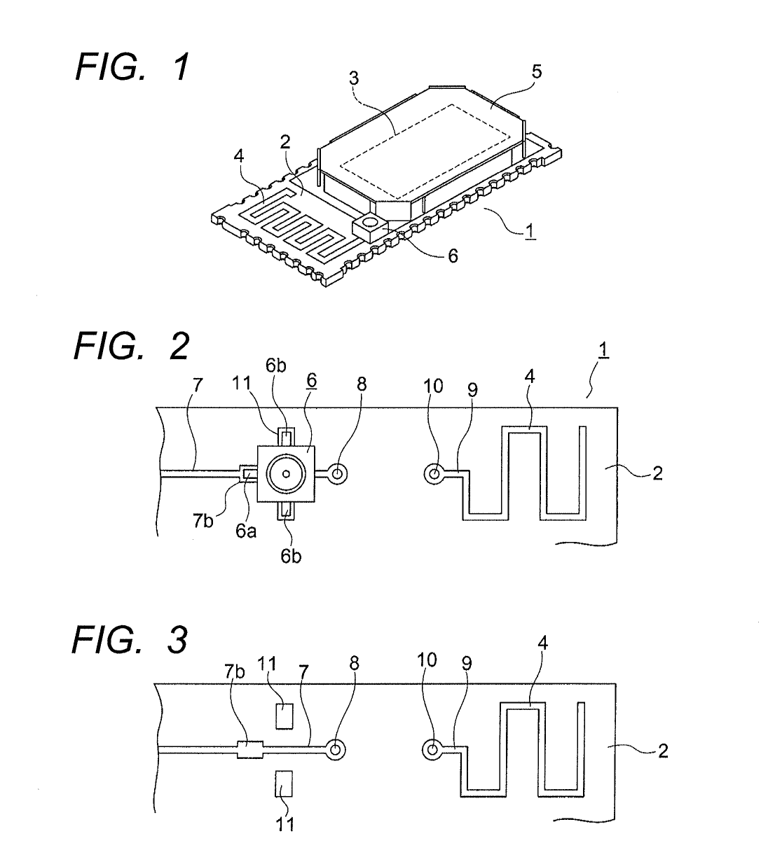

Hereinafter, embodiments of the invention will be described with reference to the accompanying drawings. FIG. 1 is an external view of a high-frequency module according to a first embodiment of the invention, FIGS. 2 and 3 are main part plan views thereof; however, in FIGS. 2 and 3, a pattern shape of an antenna element which is simplified is shown. In addition, FIG. 6 shows a main part of a high-frequency device which mounts the high-frequency module on a motherboard.

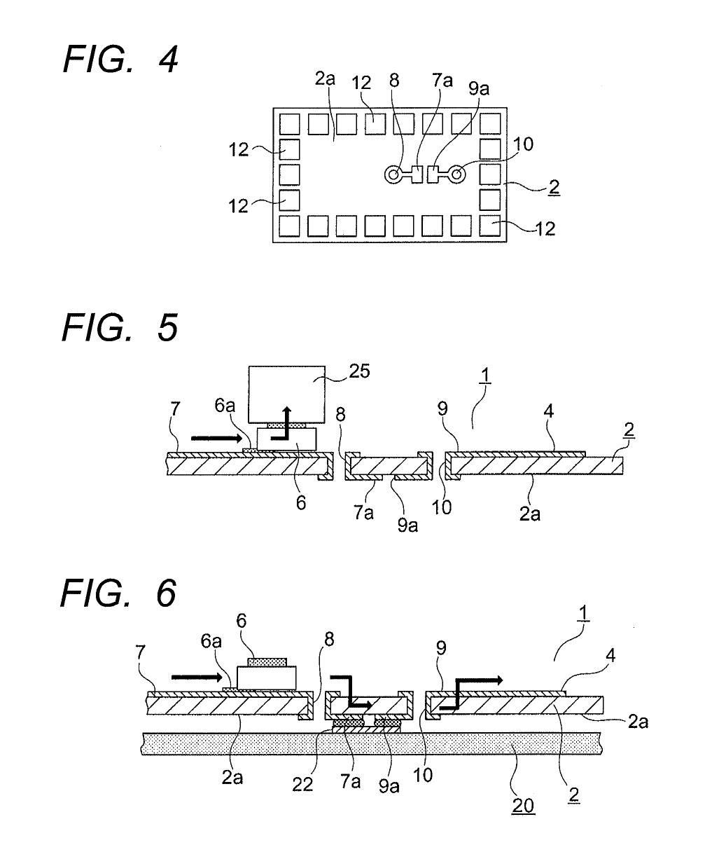

The high-frequency module 1 according to the present embodiment roughly includes a circuit board 2, an RF circuit 3 and an antenna element 4 which are arranged on the circuit board 2, a shield case 5 which is mounted on the circuit board 2 to cover the RF circuit 3, and a coaxial connector 6 which is mounted on the circuit board 2. As shown in FIGS. 3 and 5, on the circuit board 2, transmission lines are provided between the RF circuit 3 and the antenna element 4. A first transmission line 7 of the RF circuit 3 side among the transmission lines is led-out from an upper surface of the circuit board 2 to a rear surface 2a side of the circuit board 2 through a first via hole 8, and a tip portion 7a of the first transmission line 7 is formed as a solder connection land. In the same manner, a second transmission line 9 of the antenna element 4 side is led-out from the upper surface of the circuit board 2 to the rear surface 2a side thereof through a second via hole 10, and a tip portion 9a of the second transmission line 9 is also formed as the solder connection land. As shown in FIGS. 4 and 5, both the tip portions 7a and 9a are positioned in such a manner as to have a predetermined gap therebetween in a state in which electrical continuity therebetween is blocked off.

As shown in FIGS. 2 and 3, a part of the first transmission line 7 is formed as a measurement electrode 7b on the circuit board 2, and a central conductor 6a of the coaxial connector 6 is soldered to the measurement electrode 7b. In addition, on the circuit board 2, two measurement ground lands 11 which are led-out from a ground conductor portion not shown is provided in the vicinity of the measurement electrode 7b. The measurement ground lands 11 are soldered to an external conductor 6b of the coaxial connector 6. In addition, as shown in FIG. 4, in an outer peripheral portion of the rear surface of the circuit board 2, a plurality of external connection terminals 12, which is led-out from the RF circuit 3, is provided.

The shield case 5, which covers the RF circuit 3, is grounded, so that the RF circuit 3 becomes shielded in an electromagnetic manner. In addition, in the present embodiment, the antenna element 4 is formed as a pattern antenna on the circuit board 2; however, as the antenna element 4, a chip antenna, which is mounted on the circuit board 2 to be connected with the second transmission line 9, may be used. In any case, when the high-frequency module 1 is operated, a power feeding signal is supplied from the RF circuit 3 to the antenna element 4 through the first and second transmission lines 7 and 9. However, since electrical continuity between the first and second transmission lines 7 and 9 is blocked off until the high-frequency module 1 is mounted on the motherboard 20, signal transmission and reception between the RF circuit 3 and the antenna element 4 may not be performed. In other words, in the high-frequency module 1, in a state in which the tip portions 7a and 9a of the first and second transmission lines 7 and 9 are soldered to a bridging connection 1 and 22 (see, FIG. 6) which is provided as the solder connection land for bridging the transmission lines on the main board 20 when the high-frequency module 1 is mounted on the motherboard 20, the first transmission line 7 and the second transmission line 9 are connected with each other.

However, the high-frequency module 1 performs characteristic measurement for performance evaluation and adjustment of the RF circuit 3 at the assembly stage, and after the desired performance of the RF circuit 3 is able to be confirmed, the high-frequency module 1 is surface mounted on the motherboard 20. Accordingly, at the stage of performing the characteristic measurement of the RF circuit 3, electrical continuity between the first transmission line 7 and the second transmission line 9 of the high-frequency module 1 is blocked off.

When performing the characteristic measurement of the RF circuit 3, as shown in FIG. 5, a measurement plug 25 is inserted into the coaxial connector 6 from the above. The measurement plug 25 is connected to a measurement device which is not shown, and the electrical continuity between the first transmission line 7 and the second transmission line 9 is blocked off, so that it is possible to measure a transmission operating characteristic and a reception operating characteristic of the RF circuit 3 by the measurement device. In addition, arrows of FIG. 5 indicate the flow of a signal.

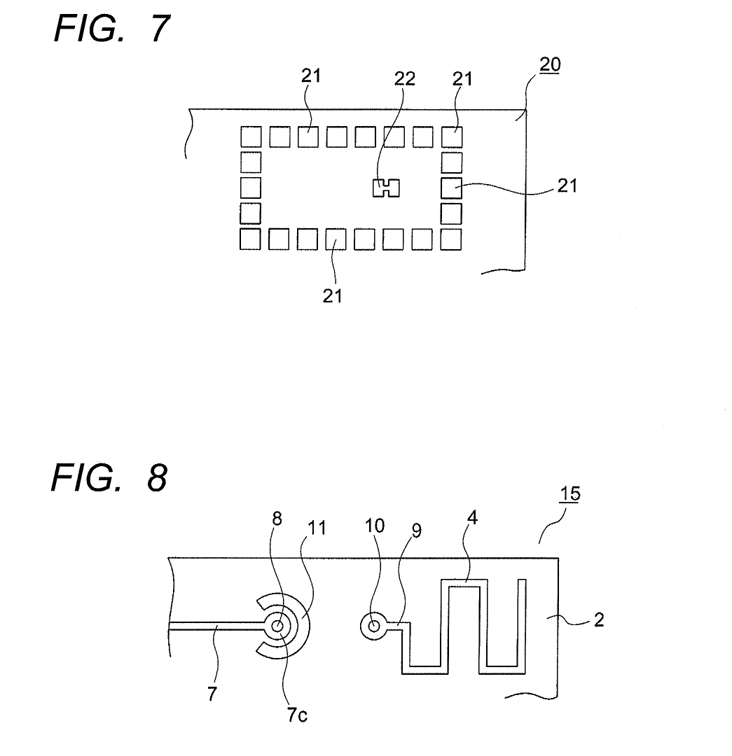

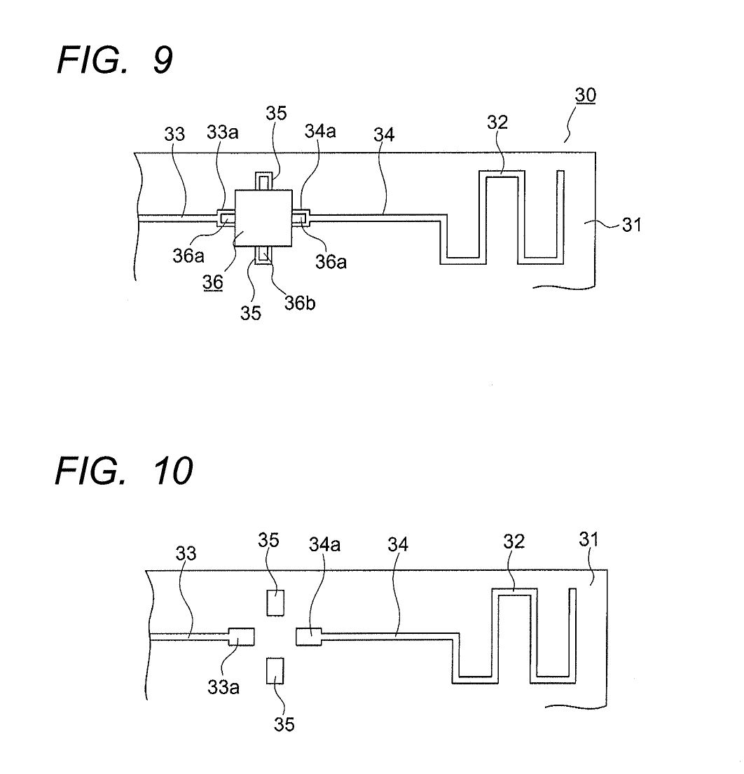

As shown in FIG. 7, on an upper surface of the motherboard 20, a connection terminal 21 group and the bridging connection land 22 are provided in a mounting region of the high-frequency module 1. When the high-frequency module 1 is mounted on the motherboard 20, by a reflow soldering process, the tip portions 7a and 9a of the first and second transmission lines 7 and 9 are soldered to the bridging connection 1 and 22 while each of the external connection terminals 12 (see, FIG. 4) is soldered to each of the connection terminals 21. As described above, in the high-frequency module 1, the first and second transmission lines 7 and 9 become connected with each other when each of the tip portions 7a and 9a is soldered to the bridging connection land 22, so that signal transmission and reception between the RF circuit 3 and the antenna element 4 are made possible as shown by arrows in FIG. 6. In addition, the RF circuit 3 becomes a state of being connected with a control circuit of the motherboard 20 side, and the like through the external connection terminal 12 group and the connection terminal 21 group, so that wireless communication and broadcast reception may be performed.

As described above, the high-frequency module 1 according to the present embodiment leads-out the tip portions 7a and 9a of the first and second transmission lines 7 and 9 to the rear surface 2a of the circuit board 2 to thereby block off electrical continuity between both the tip portions 7a and 9a until the high-frequency module 1 is mounted on the motherboard 20. Therefore, by connecting the coaxial connector 6, which is inexpensive, to a part (a measurement electrode 7b) of the first transmission line 7 on the circuit board 2, the characteristic measurement of the RF circuit 3 may be performed, and the switching connector which is expensive may become unnecessary. In addition, in the high-frequency module 1, each of the tip portions 7a and 9a of the first and second transmission lines 7 and 9 is soldered to the bridging connection 1 and 22 of the motherboard 20 in the rear surface 2a side of the circuit board 2 when the high-frequency module 1 is mounted on the motherboard 20. In other words, in the reflow soldering process performed when the high-frequency module 1 is surface mounted on the motherboard 20, soldering for connecting the tip portions 7a and 9a of the first and second transmission lines 7 and 9 with each other is collectively performed, so that a separate process or component for connecting the first transmission line 7 and the second transmission line 9 with each other is not necessary. Therefore, the high-frequency module 1 may easily achieve a reduction in manufacturing cost.

In addition, a high-frequency device (see, FIG. 6) that mounts, on the motherboard 20, the high-frequency module 1 which easily achieves the reduction in manufacturing costs may be suitable for a wireless communication device, a broadcasting receiver, or the like which is effective in cost reduction.

FIG. 8 is a main part plan view showing a pattern shape of a high-frequency module according to a second embodiment of the invention, and the same reference numerals may refer to elements corresponding to those of FIG. 2 and FIG. 3.

In a high-frequency module 15 shown in FIG. 8, the coaxial connector is not mounted on the circuit board 2, and the characteristic measurement of the RF circuit may be performed by a measurement probe (not shown). That is, in the present embodiment, the measurement ground land 11 is formed in a circular arc at the vicinity of the measurement electrode 7c while the measurement electrode 7c, which is integrated with the first via hole 8, is formed on a part of the first transmission line 7 of the RF circuit side on the circuit board 2. Therefore, the characteristic measurement of the RF circuit may be performed by the measurement probe connected to the measurement device, which is not shown, and the coaxial connector may be omitted, thereby further reducing the cost of parts. In addition, even in the present embodiment, the antenna element 4 is not limited to a pattern antenna, and a chip antenna, which is connected to the second transmission line 9, may be used as the antenna element 4.

It should be understood by those skilled in the art that various modifications, combinations, sub-combinations and alterations may occur depending on design requirements and other factors insofar as they are within the scope of the appended claims of the equivalents thereof.

What is claimed is:

1. A high-frequency module comprising:
transmission lines provided between an RF circuit and an antenna element wherein the RF circuit and the antenna element are arranged on a circuit board, and the circuit board is surface mounted on a motherboard,
wherein a second transmission line of the antenna element among the transmission lines is led-out from the top of the circuit board to a rear surface side of the circuit board through a second via hole while a first transmission line of the RF circuit side among the transmission lines is led-out from the top of the circuit board to the rear surface side through a first via hole, so that a tip portion of the first transmission line and a tip portion of the second transmission line are arranged on a rear surface of the circuit board to thereby block off electrical continuity between both the tip portions, and
both the tip portions being soldered to a solder connection land provided on the motherboard when the circuit board is surface mounted on the motherboard, so that the first transmission line and the second transmission line are connected to each other.

2. The high-frequency module according to claim 1, wherein a part of the first transmission line is used as a measurement electrode on the circuit board while a coaxial connector is mounted on the circuit board, and a central conductor of the coaxial connector is connected to the measurement electrode.

3. The high-frequency module according to claim 1, wherein a part of the first transmission line is used as a measurement electrode on the circuit board, and a measurement ground land is provided in the vicinity of the measurement electrode.

4. A high-frequency device, comprising:
a motherboard in which a solder connection land for bridging transmission lines between an RF circuit and an antenna element is provided,
the motherboard having a high-frequency module surface mounted thereto, the high-frequency module comprising:
transmission lines provided between an RF circuit and an antenna element wherein the RF circuit and the antenna element are arranged on a circuit board, and the circuit board is surface mounted on a motherboard,
wherein a second transmission line of the antenna element among the transmission lines is led-out from the top of the circuit board to a rear surface side of the circuit board through a second via hole while a first transmission line of the RF circuit side among the transmission lines is led-out from the top of the circuit board to the rear surface side through a first via hole, so that a tip portion of the first transmission line and a tip portion of the second transmission line are arranged on a rear surface of the circuit board to thereby block off electrical continuity between both the tip portions, and
both the tip portions being soldered to a solder connection land provided on the motherboard when the circuit board is surface mounted on the motherboard, so that the first transmission line and the second transmission line are connected to each other.

5. The high-frequency device, according to claim 4 wherein a part of the first transmission line is used as a measurement electrode on the circuit board while a coaxial connector is mounted on the circuit board, and a central conductor of the coaxial connector is connected to the measurement electrode.

6. The high-frequency device, according to claim 4 wherein a part of the first transmission line is used as a measurement electrode on the circuit board, and a measurement ground land is provided in the vicinity of the measurement electrode.
